(19) United States
(12) Patent Application Publication
(10) Pub. No.: US 2022/0290585 A1
(43) Pub. Date: Sep. 15, 2022

(54) CRANK SPROCKET AND MOUNTING STRUCTURE THEREFOR

(71) Applicant: TOYOTA JIDOSHA KABUSHIKI KAISHA, Toyota-shi (JP)

(72) Inventors: Koki MIYASHIRO, Toyota-shi (JP); Kazuyoshi MANABE, Toyota-shi (JP); Yoshikazu HARA, Susono-shi (JP)

(21) Appl. No.: 17/654,508

(22) Filed: Mar. 11, 2022

(30) Foreign Application Priority Data
Mar. 12, 2021 (JP) 2021-039851

(51) Int. Cl. F01L 1/02; F16H 7/18

(52) U.S. Cl. CPC F01L 1/022; F16H 7/18; F01L 2001/0537

(57) ABSTRACT

Provided is a crank sprocket that allows suppressing a transmission of vibration. The crank sprocket of the present disclosure is mounted to one end side in an axial direction of a crankshaft of an internal combustion engine, and a timing chain is wound around the crank sprocket. The crank sprocket includes a sprocket base body, and a vibration-damping resin layer formed on an inner peripheral surface or a tooth surface of the sprocket base body. The vibration-damping resin layer includes a heat-resistant resin and a vibration damping filler that converts vibration energy into thermal energy.

### CROSS REFERENCE TO RELATED APPLICATIONS

The present application claims priority from Japanese patent application JP 2021-039851 filed on Mar. 12, 2021, the entire content of which is hereby incorporated by reference into this application.

### BACKGROUND

### Description of Related Art

The present disclosure relates to a crank sprocket mounted to one end side in an axial direction of a crankshaft in an internal combustion engine, wherein a timing chain is wound around the crank sprocket, and the present disclosure relates to a mounting structure therefor.

### Background Art

Conventionally, in an internal combustion engine, such as an engine of a vehicle, a crankshaft penetrates an internal combustion engine main body including a cylinder block and the like, and the crankshaft has one end in an axial direction of the crankshaft protruding outside a cylinder block. A cylinder head is mounted to an upper portion of the cylinder block. An intake camshaft and an exhaust camshaft are disposed on the cylinder head. A camshaft driving mechanism rotatably drives respective camshafts by using the crankshaft.

The camshaft driving mechanism includes a crank sprocket, an intake cam sprocket, and an exhaust cam sprocket. The crank sprocket is mounted to one end side in the axial direction of the crankshaft. The intake cam sprocket is mounted to one end side in an axial direction of the intake camshaft. The exhaust cam sprocket is mounted to one end side in an axial direction of the exhaust camshaft. The camshaft driving mechanism further includes a timing chain that is wound around the crank sprocket and the respective cam sprockets. The timing chain drivingly rotates the respective cam sprockets by a driving rotation of the crank sprocket.

As the camshaft driving mechanism, for example, JP 2012-189201 A discloses a driving mechanism in which a chain guide is applied. The chain guide has a plurality of rollers in contact with the timing chain, and side plate members, which are disposed to face one another along a running direction of the timing chain and support both ends of a support shaft of each of the plurality of rollers. The chain guide houses vibration damping materials between the support shaft of the roller and support recesses of the side plate members supporting both ends of the support shaft.

### SUMMARY

In the camshaft driving mechanism disclosed in JP 2012-189201 A, the chain guide houses the vibration damping materials between the support shafts of the rollers in contact with the timing chain and the support recesses of the side plate members supporting both ends of the support shafts. The camshaft driving mechanism can absorb vibration of the rollers generated due to the contact with the timing chain by using the vibration damping materials. Accordingly, the camshaft driving mechanism can suppress vibration transmitted to the side plate members of the chain guide, thus allowing the reduction of vibration and noise.

The above-described conventional camshaft driving mechanism can suppress vibration generated by the contact between the timing chain and the chain guide transmitted to the engine main body, thus being radiated outside as noise. However, the camshaft driving mechanism is further required to reduce vibration caused by contact between a timing chain and another component and the like, and reduce noise generated from the vibration. Furthermore, along with electrification of vehicles, such as automobiles, a required level of an NV (noise and vibration) performance is becoming higher than before.

The present disclosure has been made in view of the above-mentioned aspects, and provides a crank sprocket that can suppress transmission of vibration and a mounting structure therefor.

To solve the above-described problem, a crank sprocket of the present disclosure is a crank sprocket mounted to one end side in an axial direction of a crankshaft of an internal combustion engine, and a timing chain is wound around the crank sprocket. The crank sprocket comprises a sprocket base body, and a vibration-damping resin layer formed on at least one of an inner peripheral surface and a tooth surface of the sprocket base body. The vibration-damping resin layer includes a heat-resistant resin and a vibration damping filler that converts vibration energy into thermal energy.

The crank sprocket of the present disclosure can suppress a transmission of vibration.

In the crank sprocket, the vibration-damping resin layer may be formed on the inner peripheral surface of the sprocket base body.

In the crank sprocket, the vibration-damping resin layer may have a thickness of 10 μm or more.

Furthermore, a mounting structure for a crank sprocket of the present disclosure is a mounting structure for a crank sprocket mounted to one end side in an axial direction of a crankshaft of an internal combustion engine. A timing chain is wound around the crank sprocket. The mounting structure comprises a vibration-damping resin layer disposed at least one of between an inner peripheral surface of a sprocket base body of the crank sprocket and an outer peripheral surface of a shaft base body of the crankshaft, and on a tooth surface of the sprocket base body. The vibration-damping resin layer includes a heat-resistant resin, and a vibration damping filler that converts vibration energy into thermal energy.

The mounting structure of the present disclosure can suppress a transmission of vibration.

In the mounting structure, the vibration-damping resin layer may be disposed between the inner peripheral surface of the sprocket base body and the outer peripheral surface of the shaft base body.

In the mounting structure, the vibration-damping resin layer may be formed on the inner peripheral surface of the sprocket base body, and be included in the crank sprocket.

In the mounting structure, the vibration-damping resin layer may have a thickness of 10 μm or more.

### Effect

The present disclosure can suppress a transmission of vibration.

### BRIEF DESCRIPTION OF THE DRAWINGS

FIG. 1 is an exploded perspective view schematically illustrating an engine to which a mounting structure for a crank sprocket according to one embodiment is applied;

FIG. 2 is a schematic cross-sectional view of the engine illustrating the mounting structure for the crank sprocket and its periphery according to the one embodiment;

FIG. 3A is an enlarged view of the portion X illustrated in FIG. 2;

FIG. 3B is a cross-sectional view along the line A-A in FIG. 3A;

FIG. 4 is a cross-sectional view schematically illustrating a falling ball testing machine;

FIG. 5 is a graph showing the sound pressure levels of the sounds that occurred at the times of the collisions of the steel ball with respect to the thicknesses of the vibration-damping resin layers in the test pieces of Examples 1 to 11 and Comparative Example; and

FIG. 6 is a graph showing overall values of sound pressure levels of vibrations transmitted to a timing chain cover in a mounted crank sprocket obtained in Example 8 and Comparative Example.

### DETAILED DESCRIPTION OF THE EMBODIMENTS

The following describes an embodiment according to a crank sprocket and a mounting structure therefor of the present disclosure.

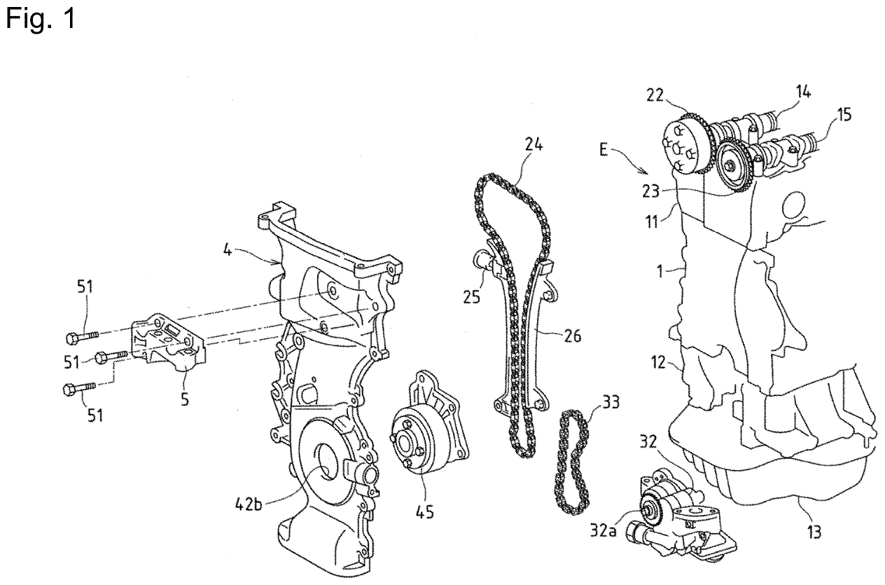

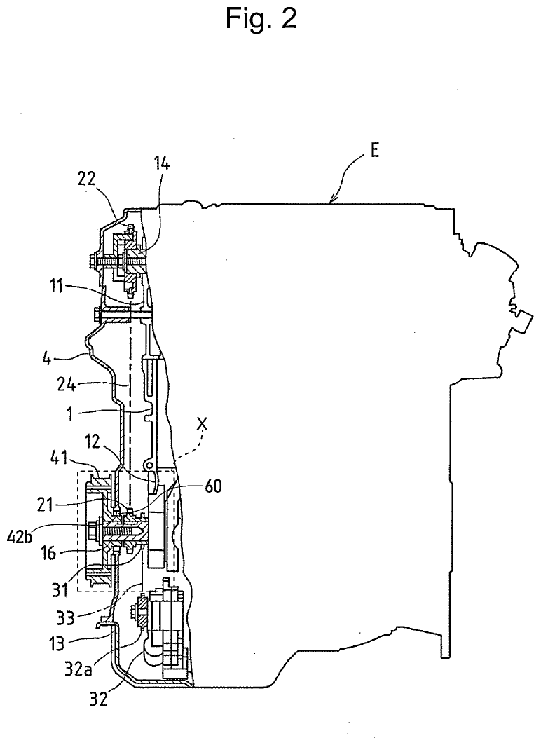

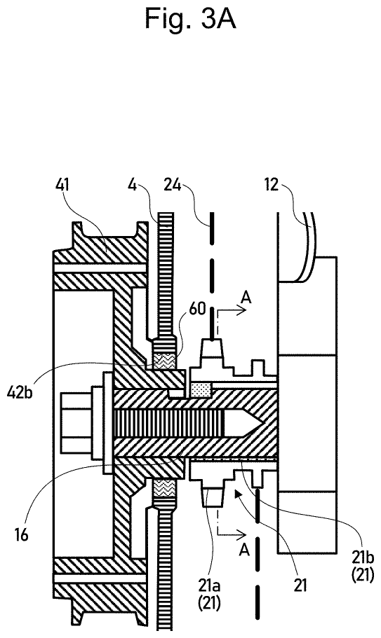

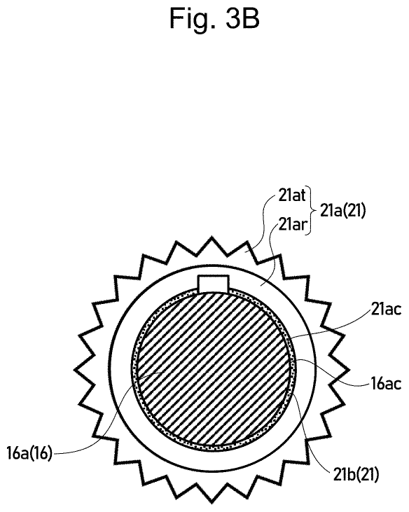

First, a description will be given on an outline of the crank sprocket and the mounting structure therefor according to the embodiment using a crank sprocket and a mounting structure therefor according to one embodiment as an example. FIG. 1 is an exploded perspective view schematically illustrating an engine to which a mounting structure for a crank sprocket according to the one embodiment is applied. FIG. 2 is a schematic cross-sectional view of the engine illustrating the mounting structure for the crank sprocket and its periphery according to the one embodiment. FIG. 3A is an enlarged view of the portion X illustrated in FIG. 2, and FIG. 3B is a cross-sectional view along the line A-A in FIG. 3A.

In an engine E (internal combustion engine) illustrated in FIG. 1, a cylinder head 11 (which is a part of the main body of the engine) is mounted to an upper portion of a cylinder block 1 (which is a part of the main body of the engine), and an oil pan 13 is mounted to a lower portion of the cylinder block 1 via a crankcase 12 (which is a part of the main body of the engine).

The cylinder block 1 and the cylinder head 11 are constituted by, for example, a metal, such as iron (cast iron), aluminum, magnesium, or an alloy containing these metals. The cylinder block 1 and the cylinder head 11 are fastened with a plurality of bolts via a non-illustrated gasket (metal gasket or liquid gasket (FIPG: Formed In Place Gasket)).

An intake camshaft 14 and an exhaust camshaft 15 are disposed on the cylinder head 11. As illustrated in FIG. 2, a crankshaft 16 is disposed on the crankcase 12. The crankshaft 16 rotatably drives each of the camshafts 14 and 15. The following describes the camshaft driving mechanism for rotatably driving each of the camshafts 14 and 15.

As illustrated in FIG. 1 and FIG. 2, the camshaft driving mechanism includes a crank sprocket 21, an intake cam sprocket 22, and an exhaust cam sprocket 23. The crank sprocket 21 is integrally rotatably mounted to one end side in an axial direction of the crankshaft 16. The intake cam sprocket 22 is integrally rotatably mounted to one end side in an axial direction of the intake camshaft 14 of the cylinder head 11. The exhaust cam sprocket 23 is integrally rotatably mounted to one end side in an axial direction of the exhaust camshaft 15 of the cylinder head 11. The camshaft driving mechanism further includes a timing chain 24 that is wound around the crank sprocket 21 and each of the cam sprockets 22 and 23. The timing chain 24 drivingly rotates each of the cam sprockets 22 and 23 by using the driving rotation of the crank sprocket 21.

As illustrated in FIG. 3A and FIG. 3B, the crank sprocket 21 includes a sprocket base body 21a and a vibration-damping resin layer 21b. The vibration-damping resin layer 21b is formed on an inner peripheral surface 21ac (inner peripheral surface of the sprocket base body) of an annular portion 21ar of the sprocket base body 21a. Accordingly, the vibration-damping resin layer 21b is disposed between the inner peripheral surface 21ac of the annular portion 21ar of the sprocket base body 21a and an outer peripheral surface 16ac of a shaft base body 16a. The vibration-damping resin layer 21b includes a heat-resistant resin and a vibration damping filler that converts vibration energy into thermal energy.

As illustrated in FIG. 1 and FIG. 2, an oil pump driving mechanism is disposed below the camshaft driving mechanism. The oil pump driving mechanism rotatably drives an oil pump 32 by using the crankshaft 16. The oil pump driving mechanism includes an oil pump driving sprocket 31 and an oil pump sprocket 32a. The oil pump driving sprocket 31 is integrally rotatably mounted to the crankshaft 16 on a side closer to the crankcase 12 than the crank sprocket 21. The oil pump sprocket 32a is integrally rotatably mounted to one end side of the oil pump 32. The oil pump driving mechanism further includes an oil pump drive chain 33 that is wound around the oil pump driving sprocket 31 and the oil pump sprocket 32a. The oil pump drive chain 33 drivingly rotates the oil pump sprocket 32a by using the driving rotation of the oil pump driving sprocket 31.

The camshaft driving mechanism and the oil pump driving mechanism are covered from the outside by a timing chain cover 4 made of an aluminum alloy and are housed in an internal space of the timing chain cover 4. The timing chain cover 4 is mounted to a surface on one end sides of the cylinder head 11, the cylinder block 1, and the crankcase 12. Reference numeral 25 in FIG. 1 indicates a chain tensioner device that controls a tensile force of the timing chain 24, and reference numeral 26 indicates a chain vibration damper that guides a tensioned section of the timing chain 24 positioned between the exhaust cam sprocket 23 and the crank sprocket 21.

An engine oil for lubricating the timing chain 24 is circulated in the space formed inside the timing chain cover 4. Therefore, a non-illustrated liquid gasket is disposed as a sealing member on a surface that is an end surface of the timing chain cover 4 and a joint surface with the cylinder head 11 and the cylinder block 1. The liquid gasket avoids oil leakage from an outer edge portion of the timing chain cover 4. As illustrated in FIG. 2 and FIG. 3A, one end in the axial direction of the crankshaft 16 is inserted through an opening 42b of the timing chain cover 4, and protrudes outside from the timing chain cover 4. On one end in the axial direction of the crankshaft 16, a crank pulley 41 for driving various kinds of auxiliary machines (such as an alternator or an air conditioner compressor) by using a belt transmission is integrally rotatably mounted. Furthermore, an oil seal 60 that avoids the oil leakage is disposed in a clearance of the opening 42b of the timing chain cover 4 through which the crankshaft 16 is inserted.

In the engine E, an engine mount bracket 5 for suspending the engine itself on a chassis is disposed on the timing chain cover 4. An iron (cast iron) having a high rigidity is used as a material of the engine mount bracket 5. The engine mount bracket 5 is fastened to the timing chain cover 4 as well as the cylinder head 11 by a plurality of fastening bolts 51,51, . . . . Furthermore, a water pump 45 is disposed to the engine E. The water pump 45 is driven by a rotation force of the crankshaft 16 and performs a circulation operation of cooling water.

In the thus configured engine E, in the mounting structure for the crank sprocket 21 according to the one embodiment, the vibration-damping resin layer 21b is disposed between the inner peripheral surface 21ac of the annular portion 21ar of the sprocket base body 21a of the crank sprocket 21 and the outer peripheral surface 16ac of the shaft base body 16a of the crankshaft 16. The vibration-damping resin layer 21b includes a heat-resistant resin and a vibration damping filler that converts vibration energy into thermal energy. Therefore, the vibration-damping resin layer 21b can suppress the transmission of the vibration between the sprocket base body 21a and the shaft base body 16a. Specifically, the vibration-damping resin layer 21b can suppress the transmission of vibration such as a vibration generated by a tooth portion 21at of the sprocket base body 21a and the timing chain 24 meshing with one another. Therefore, it is possible to suppress the vibration being transmitted to the crankshaft 16, subsequently being transmitted to the timing chain cover 4 via the oil seal 60, and radiating outside as noise.

Furthermore, the crank sprocket 21 according to the one embodiment is different from the structure of the chain guide disclosed in JP 2012-189201 A. The crank sprocket 21 according to the one embodiment can suppress vibration and noise by only forming an additional vibration-damping resin layer 21b, without significantly changing the structure of existing components.

Therefore, the crank sprocket and the mounting structure therefor according to the embodiment can suppress the transmission of vibration. The crank sprocket and the mounting structure can suppress noise generated from the vibration. Furthermore, the crank sprocket and the mounting structure can suppress the vibration and noise without significantly changing the structure of existing components.

Subsequently, the crank sprocket and the mounting structure for the crank sprocket according to the embodiment will be described in detail.

1. Crank Sprocket

The crank sprocket is mounted to one end side in the axial direction of the crankshaft of the internal combustion engine. A timing chain is wound around the crank sprocket. The crank sprocket includes a sprocket base body and a vibration-damping resin layer formed on at least one of an inner peripheral surface and a tooth surface of the sprocket base body.

(1) Sprocket Base Body

The sprocket base body has at least one of an inner peripheral surface and a tooth surface. Like the sprocket base body according to the one embodiment, the sprocket base body usually has an annular portion, and a tooth portion disposed on an outer peripheral surface of the annular portion.

The annular portion has an insertion hole formed for inserting the crankshaft into the sprocket base body, and has an inner peripheral surface (inner peripheral surface of the sprocket base body). As the material for the annular portion, steel or the like may be used. A plurality of the tooth portions are usually disposed on the outer peripheral surface of the annular portion at an equal pitch, and have tooth surfaces (tooth surfaces of the sprocket base body). The pitch of the tooth portions is not particularly limited insofar as they can mesh with the timing chain. As the material of the tooth portion, steel or the like may be used.

(2) Vibration-Damping Resin Layer

The vibration-damping resin layer is formed on at least one of the inner peripheral surface and the tooth surface of the sprocket base body. The vibration-damping resin layer includes a heat-resistant resin and a vibration damping filler that converts vibration energy into thermal energy.

The vibration-damping resin layer is disposed on the inner peripheral surface of the sprocket base body in some embodiments. This is because, unlike the vibration-damping resin layer formed on the tooth surface of the sprocket base body, a high surface pressure is not applied when the tooth portion of the sprocket base body and the timing chain mesh with one another, and thus the vibration-damping resin layer is less likely to peel off.

Although the thickness of the vibration-damping resin layer is not particularly limited, it may be, for example, 10 μm or more, particularly 20 μm or more, and especially 50 μm or more in some embodiments. This is because a blocking effect of the transmission of vibration can be sufficiently obtaining by such thickness. The thickness of the vibration-damping resin layer may be, for example, 400 μm or less, particularly 200 μm or less, and especially 100 μm or less in some embodiments. This is because such thickness saturates an improvement of the blocking effect of the vibration, and facilitates forming a layer by coating.

The heat-resistant resin is not particularly limited insofar as it has a thermal distortion temperature of 100° C. or more, but the heat-resistant resin may have a thermal distortion temperature of 150° C. or more in some embodiments. The heat-resistant resin is not particularly limited, but examples include polyamide-imide resin, polyimide resin, phenol resin, epoxy resin, polyether sulfone resin, polyphenyl sulfide resin or the like. From the aspect of workability when forming a coating film and a thermal resistance against heat generated by friction, polyamide-imide resin may be employed in some embodiments. These types of heat-resistant resin may be used alone, or two or more types may be used together.

The vibration damping filler converts vibration energy into thermal energy. A material of the vibration damping filler is not particularly limited, but may be classified roughly into an easily deformed material having a low elastic modulus and a material inside which an energy dissipation can easily occur. An easily deformed material having a low elastic modulus specifically refer to a material that is solid and significantly has both characteristics of elasticity and viscosity. Elasticity and viscosity are characteristics that every material has simultaneously, but the easily deformed material having a low elastic modulus significantly has these characteristics simultaneously. Therefore, the vibration-damping resin layer containing the easily deformed material having a low elastic modulus can increase rubber elasticity of the vibration-damping resin layer itself in ordinary temperature. Accordingly, the vibration-damping resin layer is considered to be capable of effectively absorbing vibration input from outside and converting it into thermal energy, and thus effectively blocking the transmission of the vibration. On the other hand, a material inside which an energy dissipation can easily occur can attenuate vibration by diffusing the vibration in an air layer existing inside the material and thus converting the vibration into thermal energy. Therefore, the vibration-damping resin layer containing the material inside which an energy dissipation can easily occur is considered to be capable of effectively blocking the transmission of vibration.

Examples of the easily deformed material having a low elastic modulus include, a thermoplastic elastomer, a urethane-based compound, a polyethylene-based compound, an ester copolymer, a rubber-based material, and the like. The thermoplastic elastomer generally has characteristics of rubber in ordinary temperature, and has characteristics equivalent to a thermoplastic plastic in high temperature. Examples of the thermoplastic elastomer include a styrene-based thermoplastic elastomer, an olefin-based thermoplastic elastomer, a vinyl chloride-based thermoplastic elastomer, a urethane-based thermoplastic elastomer, an ester-based thermoplastic elastomer, an amide-based thermoplastic elastomer, and the like. These examples are disclosed in JP 2016-113614 A, JP 2017-197733 A, and the like. Examples of a urethane-based compound include a urethane resin and the like. These examples are disclosed in JP H08-183945 A and the like. Examples of the polyethylene-based compound include an ethylene homopolymer, a copolymer of ethylene and a-olefin monomer, and the like. These examples are disclosed in JP 2009-532570 T and the like. Examples of the ester copolymer include an acrylic acid ester copolymer and the like. These examples are disclosed in Japanese Patent No. 3209499 and the like. Examples of the rubber-based material include a butyl rubber, a fluorine rubber, and the like. These examples are disclosed in JP 2009-236172 A and the like.

Examples of the material inside which an energy dissipation can easily occur include a microcapsule-based material, a low density material, and the like. Examples of the microcapsule-based material include thermally expandable microcapsules containing vapor that expands at a predetermined temperature range inside a shell made of thermoplastic polymer, and the like. These examples are disclosed in JP 2013-18855 A, and the like. Examples of the low density material are, for example, general materials containing an air layer inside the material, specifically, for example, a foam material, a porous body, a nonwoven fabric, a layered compound, and the like. These examples are disclosed in, JP H03-221173 A, Japanese Patent No. 4203589, and the like. The above-mentioned types of vibration damping filler may be used alone, or two or more types may be used together.

In addition to the heat-resistant resin and the vibration damping filler, the vibration-damping resin layer may contain an optional component, such as a solid lubricant and hard particles. This is because the vibration-damping resin layer can be provided with characteristics such as wear resistance, seizure resistance, and low friction. The solid lubricant is not limited, but examples include poly tetra fluoro ethylene (PTFE), molybdenum disulfide (MoS₂), graphite (black lead), and the like. These types of solid lubricants may be used alone, or two or more types may be used together. The hard particles are not particularly limited, but examples include alumina (Al₂O₃), silica, and the like. These types of hard particles may be used alone, or two or more types may be used together.

The volume ratio of the vibration damping filler to a total volume of the heat-resistant resin and the vibration damping filler in the vibration-damping resin layer is not particularly limited, but the volume ratio may be, for example, in the range of 20 vol % or more and 80 vol % or less, especially, in the range of 40 vol % or more and 60 vol % or less in some embodiments. This is because, by the volume ratio being equal to or above the lower limit of these ranges, vibration energy can be more efficiently converted to thermal energy using the vibration damping filler. Another reason is because, by the volume ratio being equal to or below the upper limit of these ranges, a durability as a resin coating (such as wear resistance or sticking force) can be maintained. The volume ratio of an optional component other than the heat-resistant resin and the vibration damping filler in the vibration-damping resin layer is not particularly limited and may be selected according to types.

The vibration-damping resin layer is not particularly limited insofar as it suppresses the transmission of vibration at a desired frequency. For example, the vibration-damping resin layer suppresses the transmission of vibration at a frequency of 2 kHz in some embodiments. This is because the vibration-damping resin layer can especially suppress noise effectively. The vibration-damping resin layer can be adjusted to suppress the transmission of vibration at a desired frequency by adjusting, for example, the types and the contained amounts of the respective components such as the vibration damping filler, the heat-resistant resin, and the like in the vibration-damping resin layer, the thickness of the vibration-damping resin layer, and the like.

A forming method of the vibration-damping resin layer is not particularly limited, but examples include the following method, and the like. First, a dissolution liquid is prepared by dissolving a predetermined amount of the heat-resistant resin into an organic solvent. Next, a predetermined amount of the vibration damping filler is added to the dissolution liquid, and an optional component is further added as necessary, and kneaded to prepare a coating material. Subsequently, the coating material is applied on the inner peripheral surface or the tooth surface of the sprocket base body. Next, the coating material applied on the sprocket base body is heated, dried, and hardened. Thus, the vibration-damping resin layer is formed.

The organic solvent used in the above-described method is not particularly limited and is selected according to a type of the heat-resistant resin. For example, when the polyamide-imide resin is used as the heat-resistant resin, examples of the organic solvent include N-methyl-2-pyrrolidone (NMP), N-ethyl-2-pyrrolidone (NEP), 1,3-dimethyl-2-imidazolidinone (DMI), γ-butyrolactone (GBL), and the like. When using the epoxy resin, examples of the organic solvent include methyl ethyl ketone (MEK), toluene, and the like.

A method of kneading to prepare the coating material includes, for example, using a kneader to perform kneading for one hour, and the like. A method of applying the coating material on the sprocket base body is not particularly limited and a common coating method may be used, such as a spray coating, a screen-printing, a dipping, and the like. A heating condition for drying and hardening the coating material is not particularly limited, but examples include heating at a temperature of 100° C. or above and 370° C. or below for 30 minute or more and 3 hours or less, and the like.

2. Mounting Structure for Crank Sprocket

In a mounting structure for a crank sprocket, the crank sprocket around which a timing chain is wound is mounted to one end side in an axial direction of a crankshaft of an internal combustion engine. In the crank sprocket mounting structure, a vibration-damping resin layer is disposed at least one of between an inner peripheral surface of a sprocket base body and an outer peripheral surface of a shaft base body of the crank sprocket, and on a tooth surface of the sprocket base body. The vibration-damping resin layer includes a heat-resistant resin and a vibration damping filler that converts vibration energy into thermal energy.

As the mounting structure for the crank sprocket, the vibration-damping resin layer is disposed between the inner peripheral surface of the sprocket base body and the outer peripheral surface of the shaft base body in some embodiments. This is because, unlike the vibration-damping resin layer formed on the tooth surface of the sprocket base body, a high surface pressure is not applied when the tooth portion of the sprocket base body and the timing chain mesh with one another, thus the vibration-damping resin layer is less likely to peel off.

The vibration-damping resin layer in the mounting structure is disposed in the crank sprocket in some embodiments. Specifically, the vibration-damping resin layer is formed on at least one of the inner peripheral surface and the tooth surface of the sprocket base body and is disposed in the crank sprocket in some embodiments. This is because, compared with a case where the vibration-damping resin layer is formed on the outer peripheral surface of the shaft base body, and is disposed in the crankshaft, it becomes easier to handle members in, for example, a forming process of the vibration-damping resin layer. The vibration-damping resin layer in the mounting structure is especially formed on the inner peripheral surface of the sprocket base body and is disposed in the crank sprocket in some embodiments.

The thickness of the vibration-damping resin layer in the mounting structure, and the heat-resistant resin and the vibration damping filler included in the vibration-damping resin layer are the same as the described items in “1. Crank Sprocket (2) Vibration-damping resin layer”, and thus description will be omitted here.

### EXAMPLES

The crank sprocket and the mounting structure for the crank sprocket according to the embodiment will be further described in detail in the following with examples and comparative examples.

### Example 1

First, a coating material used for forming a vibration-damping resin layer of a crank sprocket was prepared. Specifically, first, polyamide-imide resin was prepared as a heat-resistant resin, and a dissolution liquid was prepared by dissolving a predetermined amount of the polyamide-imide resin in N-ethyl-2-pyrrolidone (NEP) (organic solvent). Next, thermoplastic elastomer was prepared as a vibration damping filler, and a predetermined amount of the thermoplastic elastomer was added to the dissolution liquid, and kneaded for one hour using a kneader. Accordingly, a coating material was prepared such that a volume ratio of the vibration damping filler to the total volume of the heat-resistant resin and the vibration damping filler in the vibration-damping resin layer was 50 vol %.

Subsequently, a test piece in which the vibration-damping resin layer was formed on the surface of a block shaped substrate was created. Specifically, first, a block shaped substrate made of SUS440C was prepared, and a predetermined amount of the coating material was applied on a surface of the substrate by spray coating. Next, the coating material which was applied on the substrate was heated at 180° C. for 90 minutes to volatilize an organic solvent, thus drying and hardening the coating material. Accordingly, a test piece was created by forming a vibration-damping resin layer with the thickness of 1 μm on the surface of the substrate.

### Example 2

A test piece was created similarly to Example 1, except that the vibration-damping resin layer was formed so as to have the thickness of 5 μm.

### Example 3

A test piece was created similarly to Example 1, except that the vibration-damping resin layer was formed so as to have the thickness of 10 μm.

### Example 4

A test piece was created similarly to Example 1, except that the vibration-damping resin layer was formed so as to have the thickness of 20 μm.

### Example 5

A test piece was created similarly to Example 1, except that the vibration-damping resin layer was formed so as to have the thickness of 50 μm.

### Example 6

A test piece was created similarly to Example 1, except that the vibration-damping resin layer was formed so as to have the thickness of 100 μm.

### Example 7

A test piece was created similarly to Example 1, except that the vibration-damping resin layer was formed so as to have the thickness of 200 μm.

### Example 8

First, the coating material was prepared similarly to Example 1, except that a urethane resin was prepared as the vibration damping filler and added to the dissolution liquid by a predetermined amount.

Subsequently, a test piece was created similarly to Example 1, except that the coating material prepared in this example was used and the vibration-damping resin layer was formed so as to have the thickness of 100 μm.

Subsequently, a crank sprocket in which the vibration-damping resin layer was formed on an inner peripheral surface of a sprocket base body was created, and mounted to an engine, thus creating a mounted crank sprocket.

Specifically, first, a sprocket base body made of SUS440C was prepared. Next, the coating material prepared in this example was applied by a predetermined amount on the inner peripheral surface of the sprocket base body by spray coating. Next, the coating material applied on the sprocket base body was heated at 180° C. for 90 minutes to volatilize the organic solvent, thus drying and hardening the coating material. Accordingly, a crank sprocket was created by forming a vibration-damping resin layer with the thickness of 100 μm in the inner peripheral surface of the sprocket base body.

Next, the cylinder block, the cylinder head, the crankshaft, the camshaft, the cam sprocket, the timing chain, the timing chain cover, and the like were prepared. Next, the crank sprocket was integrally rotatably mounted to one end side in an axial direction of the crankshaft. At this point, the vibration-damping resin layer was disposed between the inner peripheral surface of the sprocket base body of the crank sprocket and the outer peripheral surface of the shaft base body of the crankshaft. Next, the cylinder block, the cylinder head, the crankshaft, the camshaft, and the cam sprocket were assembled, and mounted to the crankshaft to which the crank sprocket was mounted. Next, the timing chain was wound around the crank sprocket and the cam sprocket, and the timing chain cover and the like were mounted to the cylinder block and the like. Accordingly, the engine as well as the mounted crank sprocket were built.

### Example 9

A test piece was created similarly to Example 8, except that the vibration-damping resin layer was formed so as to have the thickness of 200 μm.

### Example 10

First, the coating material was prepared similarly to Example 1, except that a microcapsule was prepared as the vibration damping filler and a predetermined amount of the microcapsule was added to the dissolution liquid.

Subsequently, a test piece was created similarly to Example 1, except that the coating material prepared in this example was used to form the vibration-damping resin layer with the thickness of 100 μm.

### Example 11

A test piece was created similarly to Example 10, except that the vibration-damping resin layer was formed so as to have the thickness of 200 μm.

### Comparative Example

First, a block shaped substrate similar to Example 1 was prepared and used directly as a test piece without forming the vibration-damping resin layer.

Subsequently, an engine as well as a mounted crank sprocket were produced similarly to Example 1, except that a sprocket base body similar to Example 8 was prepared, and was used directly as a crank sprocket without forming a vibration-damping resin layer.

[Evaluation of Influence of Vibration-Damping Resin Layer Thickness on NV Performance in Falling Ball Test]

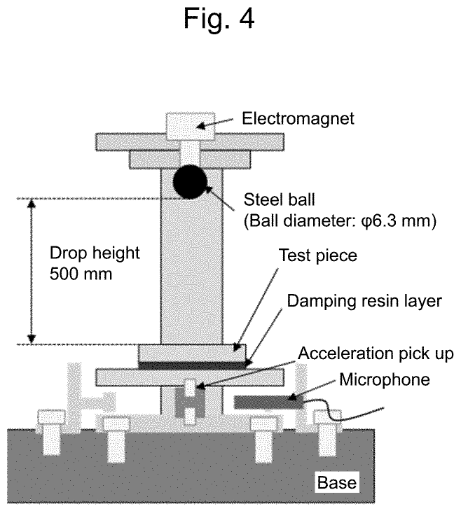

A falling ball test was performed on the test pieces obtained by Examples 1 to 11 and Comparative Example to evaluate influence of the thicknesses of the vibration-damping resin layer on an NV performance. FIG. 4 is a cross-sectional view schematically illustrating the falling ball testing machine.

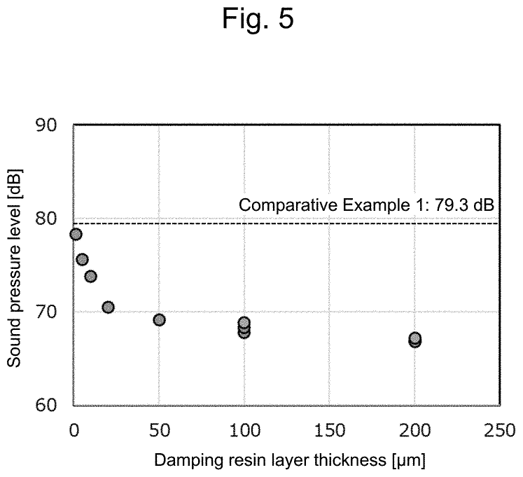

In the falling ball test, as illustrated in FIG. 4, the test piece was installed on a steel plate on an acceleration pick up installed in an upper portion of a base of the falling ball testing machine. When installing, the test pieces of Examples 1 to 11 were installed such that the vibration-damping resin layer was in contact with the steel plate. This is because the purpose of the falling ball test is to measure how much noise is suppressed, when an impact is applied to the vibration-damping resin layer disposed in a clearance between components. In the falling ball testing machine, a steel ball of φ6.3 mm made of SUJ2 is held directly above the test piece by an electromagnet. In the falling ball test, the height of the steel ball (distance from an upper surface of the test piece) before falling is set at 500 mm, and by turning off a magnetic force of the falling ball testing machine, the steel ball drops and collides with the test piece. Subsequently, a sound occurred at the time of the collision is collected by a microphone installed directly above the test piece, and a sound pressure level of the overall value in frequency band range of 20 Hz to 10 kHz was measured. The measurement result is shown below in Table 1. FIG. 5 is a graph showing the sound pressure levels of the sounds that occurred at the times of the collisions of the steel ball with respect to the thicknesses of the vibration-damping resin layers in the test pieces of Examples 1 to 11 and Comparative Example.

As illustrated in Table 1 and FIG. 5 below, since the sound pressure level is reduced in accordance with an increase in the thickness of the vibration-damping resin layer, it is considered that the NV performance improves in accordance with the increase in the thickness of the vibration-damping resin layer. Comparing the test piece of the Comparative Example made only of substrates, and the test pieces of examples 1 to 7 in which the compositions of the vibration-damping resin layers are the same, while the test piece in which the thickness of the vibration-damping resin layer is thinner than 10 μm showed a reduction effect of the sound pressure level with respect to the test piece made only of the substrates, a significant reduction effect is not recognized. On the other hand, with the test piece in which the thickness of the vibration-damping resin layer is 10 μm or more, a reduction effect of the sound pressure level of 5 dB or more with respect to the test piece made only of the substrates was recognized. Accordingly, the thickness of the vibration-damping resin layer may be 10 μm or more, particularly 20 μm or more, and especially 50 μm or more in some embodiments. Furthermore, as illustrated in Table 1 and FIG. 5 below, even when a type of the vibration damping filler of the vibration-damping resin layer is changed, the same trend can be recognized.

[Evaluation of NV Performance of Mounted Crank Sprocket]

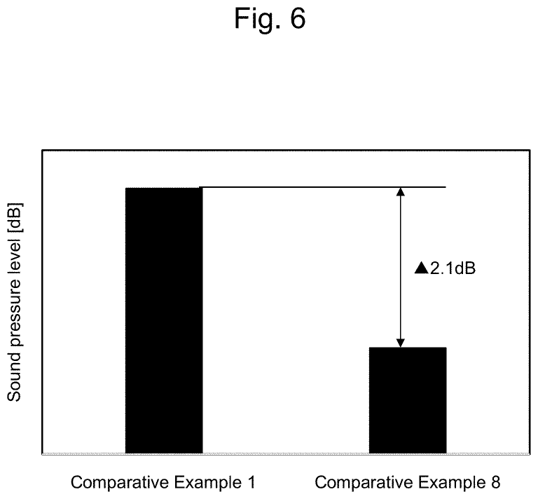

The NV performances of the mounted crank sprocket obtained by Example 8 and Comparative Example were evaluated. Specifically, a microphone for measuring sound pressure was installed in front of the timing chain cover (30 cm) of an engine to which a mounted crank sprocket was mounted. In this state, an engine actuator was rotated manually at a rotation speed of 1000 to 5000 rpm to drive the engine. Furthermore, by using the microphone, the overall value of the sound pressure level in the frequency band range of 20 Hz to 20 kHz radiated by the timing chain cover was measured. The measurement result is shown in Table 1 below. FIG. 6 is a graph indicating the overall values of the sound pressure levels of the vibrations transmitted to the timing chain cover in the mounted crank sprocket obtained by Example 8 and Comparative Example. Note that, in Table 1 and FIG. 6 below, the overall value of the sound pressure level in the comparative example is set as a reference value, and the overall values of the sound pressure levels in the examples are indicated by a relative value with respect to the reference value.

As illustrated in Table 1 and FIG. 6 below, in the mounted crank sprocket obtained in Example 8, compared with the mounted crank sprocket obtained in Comparative Example, a significant reduction effect of the sound pressure level can be recognized. When forming the vibration-damping resin layer on the inner peripheral surface of the sprocket base body, for example, it is possible to prevent vibrations such as the vibration generated by the tooth portion of the sprocket base body and the timing chain meshing with one another, and the like, from being transmitted from the sprocket base body to the shaft base body.

TABLE 1

| | | | | | Mounted |
|---|---|---|---|---|---|
| | | | | | crank |
| | | | | | sprocket |
| | | | | Falling | NV per- |
| | | | | ball test | formance |
| | Vibration-damping resin layer | | | Sound | Sound |
| | Heat- | Vibration | Thick- | pressure | pressure |
| | resistant | damping | ness | level | level |
| | resin | filler | [μm] | [dB] | [dB] |
| Compara- | Without vibration- | | | 79.3 | Reference |
| tive | damping resin layer | | | | value |
| example | | | | | |
| Example 1 | Poly- | Thermo- | 1 | 78.3 | — |
| Example 2 | amide- | plastic | 5 | 75.6 | — |
| Example 3 | imide | elastomer | 10 | 73.8 | — |
| Example 4 | | | 20 | 70.5 | — |
| Example 5 | | | 50 | 69.1 | — |
| Example 6 | | | 100 | 67.8 | — |
| Example 7 | | | 200 | 66.9 | — |
| Example 8 | | Urethane | 100 | 68.3 | −2.1 |
| Example 9 | | resin | 200 | 66.8 | — |
| Example 10 | | Micro- | 100 | 68.8 | — |
| Example 11 | | capsule | 200 | 67.2 | — |

While the embodiment according to the crank sprocket and the mounting structure for the crank sprocket of the present disclosure have been described in detail above, the present disclosure is not limited thereto, and can be subjected to various kinds of changes of design without departing from the spirit of the present disclosure described in the claims.

All publications, patents and patent applications cited in the present description are herein incorporated by reference as they are.

### DESCRIPTION OF SYMBOLS

E Engine (internal combustion engine)
1 Cylinder block (main body of engine)
4 Timing chain cover
11 Cylinder head (main body of engine)
12 Crankcase (main body of engine)
13 Oil pan
14 Intake camshaft
15 Exhaust camshaft
16 Crankshaft
16a Shaft base body
16ac Outer peripheral surface
21 Crank sprocket
21a Sprocket base body
21ac Inner peripheral surface
21b Vibration-damping resin layer
22 Intake cam sprocket
23 Exhaust cam sprocket
24 Timing chain
25 Chain tensioner device
26 Chain vibration damper
31 Oil pump driving sprocket
32 Oil pump
32a Oil pump sprocket
33 Oil pump drive chain
41 Crank pulley
42b Opening
60 Oil seal

What is claimed is:

1. A crank sprocket mounted to one end side in an axial direction of a crankshaft of an internal combustion engine, a timing chain being wound around the crank sprocket, the crank sprocket comprising:
a sprocket base body; and
a vibration-damping resin layer formed on at least one of an inner peripheral surface and a tooth surface of the sprocket base body,
wherein the vibration-damping resin layer includes a heat-resistant resin and a vibration damping filler that converts vibration energy into thermal energy.

2. The crank sprocket according to claim 1, wherein
the vibration-damping resin layer is formed on the inner peripheral surface of the sprocket base body.

3. The crank sprocket according to claim 1, wherein
the vibration-damping resin layer has a thickness of 10 μm or more.

4. A mounting structure for a crank sprocket mounted to one end side in an axial direction of a crankshaft of an internal combustion engine, a timing chain being wound around the crank sprocket, the mounting structure for the crank sprocket comprising
a vibration-damping resin layer disposed at least one of between an inner peripheral surface of a sprocket base body of the crank sprocket and an outer peripheral surface of a shaft base body of the crankshaft, and on a tooth surface of the sprocket base body,
wherein the vibration-damping resin layer includes a heat-resistant resin and a vibration damping filler that converts vibration energy into thermal energy.

5. The mounting structure for the crank sprocket according to claim 4, wherein
the vibration-damping resin layer is disposed between the inner peripheral surface of the sprocket base body and the outer peripheral surface of the shaft base body.

6. The mounting structure for the crank sprocket according to claim 5, wherein
the vibration-damping resin layer is formed on the inner peripheral surface of the sprocket base body, and is included in the crank sprocket.

7. The mounting structure for the crank sprocket according to claim 4, wherein
the vibration-damping resin layer has a thickness of 10 μm or more.
